(19) United States
(12) Patent Application Publication
(10) Pub. No.: US 2006/0145830 A1
(43) Pub. Date: Jul. 6, 2006

(54) Object identification system and device

(76) Inventor: Jean K. Comstock, Silver Spring, MD (US)

Correspondence Address: JOSEPH G. SEEBER;POST OFFICE BOX 750, GREAT FALLS, VA, 22066, US

(21) Appl. No.: 11/014,550

(22) Filed: Dec. 16, 2004

(51) Int. Cl. G08B 26/00

(52) U.S. Cl. 340/505

(57) ABSTRACT

The object identification system of the present invention comprises: a hand-held mechanism or remote control unit employed by the user to set up the system, and to locate an object or objects once the system is set up; and an identification device which is attachable to the object(s) to be identified, and which has an array of lights built into it for uniquely identifying the object(s) as belonging to the user of the system and device. More specifically, the remote control unit is initially employed by the user to program the identification device to respond to a polling signal from the remote control unit by illuminating, in a certain sequence or with a certain pattern, lights built into the identification device so as to uniquely identify, as belonging to the user, the object(s) to which the identification device is attached. Once the identification device is programmed, the remote control unit can be used to generate a polling signal, in response to which the identification device illuminates its lights in the certain sequence or with the certain pattern to identify the object(s) as belonging to the user.

### TECHNICAL FIELD

The present invention generally relates to an object identification system and device, and more particularly to a luggage identification system and device.

### BACKGROUND ART

There is a need in the prior art for an object identification system and device, and this is especially true in the area of luggage identification and retrieval such as occurs in an airport or in another type of transportation terminal. Specifically, a traveler needs a system and device which will facilitate the location, identification and retrieval of his or her luggage after completion of travel via airliner, train, or the like.

There have been attempts to solve this problem, as exemplified by the following U.S. Pat. Nos. 6,297,737; 6,304,183; 6,342,836; 6,462,658; and 6,697,103. However, none of these patents discloses a system or device which solves the problems or provides the capabilities solved and provided by the system and device of the present invention.

Specifically, whereas each of the above-identified patents discloses an object locating and/or sensing system or device, most of the patents do not disclose a system or device which precludes the possibility that a user will activate a response signal from an identification device attached to someone else's object, and which precludes the possibility that identical response signals will be generated by more than one object simultaneously. Therefore, there is a need in the prior art for an object identification system in which a remote control unit transmits a polling signal having a characteristic (e.g., frequency) unique to the remote control unit, and in which an object identifying device attached to an object to be located generates a response signal preselected by the user and unique to the user's system. More specifically, none of the patents discloses a system or device which provides a user with the capabilities of: selecting a frequency for the polling signal to be generated by the remote control unit; and employing a remote control unit to control a device fixed to the object so as to designate a specific sequence or pattern of lights located on the device so that, in response to a polling signal subsequently generated by the remote control unit, the device uniquely identifies the object by activating and displaying the specifically selected, unique sequence or pattern of lights located on the device.

### DISCLOSURE OF INVENTION

The present invention generally relates to an object identification system and device, and more particularly to a luggage identification system and device.

The object identification system of the present invention comprises: a hand-held mechanism or remote control unit employed by the user to set up the system, and to locate an object or objects once the system is set up; and an identification device which is attachable to the object or objects to be identified, and which has an array of lights built into it for uniquely identifying the object or objects as belonging to the user of the system and device.

More specifically, the remote control unit is initially employed by the user to program the identification device to respond to a polling signal from the remote control unit by illuminating, in a certain sequence or with a certain pattern, lights built into the identification device so as to uniquely identify, as belonging to the user, the object or objects to which the identification device is attached.

Therefore, it is a primary object of the present invention to provide an object identification system and device.

It is an additional object of the present invention to provide an object identification system which provides a remote control unit for programming an identification device to display a preselected pattern or sequence of lights uniquely identifying an object or objects to which the identification device is attached.

It is an additional object of the present invention to provide an object identification system which includes an identification device which responds to a polling signal from a remote control unit by displaying a preselected sequence or pattern of flashing or illuminated lights so as to uniquely identify the object(s) to which the device is attached.

The above and other objects, and the nature of the invention, will be more clearly understood by reference to the following detailed description, the accompanying drawings and the appended claims.

### BRIEF DESCRIPTION OF DRAWINGS

FIG. 1 is a diagram of the system of the present invention.

FIG. 2 is a plan view of the remote control unit of the system of the present invention.

FIG. 3 is a plan view of the object identifying device containing a name tag and a light array in accordance with the present invention.

FIG. 4 is a block diagram of the electrical components of the remote control unit and the object identifying device of the present invention.

### BEST MODE FOR CARRYING OUT THE INVENTION

The invention will now be described in more detail with reference to the various figures of the drawings.

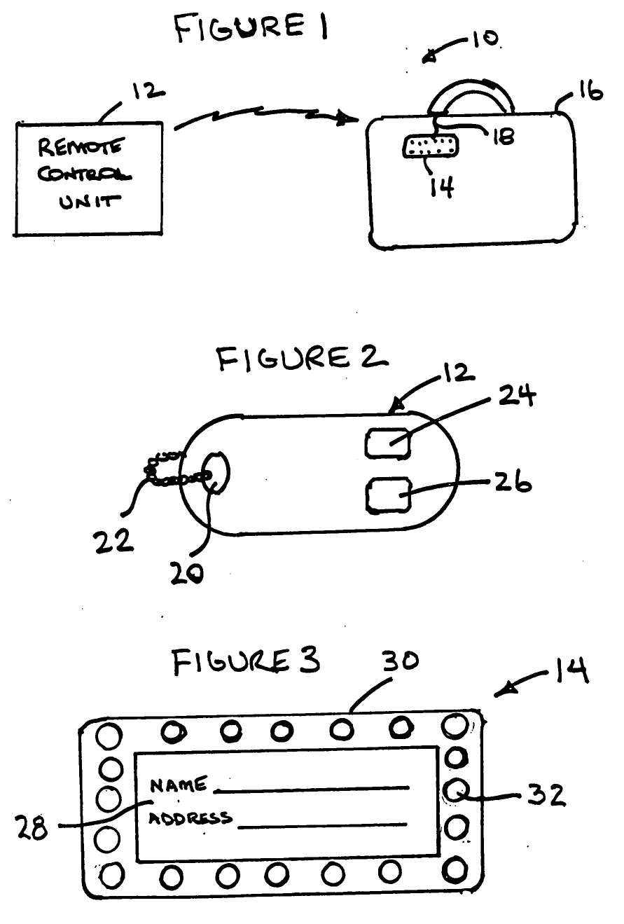

FIG. 1 is a diagram of the system of the present invention. As seen in FIG. 1, the object identification system 10 basically comprises a remote control unit 12 and an object identifying device 14. The object identifying device 14 is somewhat similar to an identification tag for luggage in that it is connected to luggage 16 by a chain 18. However, other means for connecting the device 14 to luggage 16 may be employed within the scope of the present invention.

FIG. 2 is a plan view of the remote control unit of the system of the present invention. As seen in FIG. 2, the remote control unit 12 is a small hand-held mechanism. For example, remote control unit 12 is similar in design to the remote control device which drivers employ to lock and unlock their vehicles and perform other functions with respect to their vehicles. Thus, remote control unit 12 has a hole 20 at one end, through which hole 20 a chain 22 can be attached for holding keys or other devices.

In addition, the remote control unit 12 has control buttons 24 and 26 which serve important functions. Control button 24 is used by the user, during setup of the object identifying device 14, to program the object identifying device 14 to display a selected pattern or sequence of illuminated lights or flashing lights when the object identifying device 14 is polled by the remote control unit 12. Control button 26 is used by the user during the object identifying phase to send a polling signal from the remote control unit 12 to the object identifying device 14, in response to which the object identifying device 14 displays the previously selected pattern or sequence of illuminated lights or flashing lights, thereby identifying the object (e.g., luggage 16) for the user.

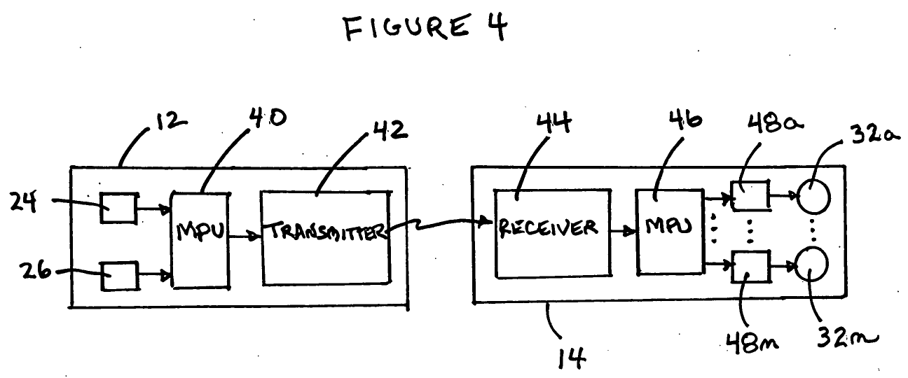

FIG. 3 is a plan view of the object identifying device containing a name tag and a light array in accordance with the present invention. As seen in FIG. 3, the object identifying device 14 has a central portion 28 which can contain a standard identification tag listing the name, address, etc. of the owner of the luggage 16. The object identifying device 14 also has a peripheral portion 30 containing a built-in plurality of lights 32.

FIG. 4 is a block diagram of the electrical components of the remote control unit and the object identifying device of the present invention. As seen therein, the remote control unit 12 has a microprocessor unit (MPU) 30 which receives inputs from control buttons 24 and 26, and remote control unit 12 also has a transmitter 42connected to the MPU 30. In accordance with the invention, the MPU 30 is programmed to respond to an input from control button 24 by sending a signal, via transmitter 42, to object identifying device 14 so as to program object identifying device 14 to select a predetermined pattern or sequence of lights 32 for display, either in a continuous or flashing manner, when the object identifying device 14 is subsequently polled by remote control unit 12.

As also seen in FIG. 4, the object identifying device 14 has a receiver 44 for receiving signals from the transmitter 42 of remote control unit 12, and an MPU 46 connected to the receiver 44 for receiving the signals received by the receiver 44. As is well known in the art, receiver 44 can include an analog-to-digital converter (ADC) for converting analog signals received by receiver 44 to digital form for provision to MPU 46.

Two types of signals are transmitted by remote control unit 12 to object identifying device 14, and are thus provided to MPU 46: (1) setup or programming signals resulting from activation of control button 24 of remote control unit 12 during the setup phase of operation, in response to which the pattern or sequence of lights to be displayed by object identifying device 14 is selected; and (2) polling signals resulting from activation of control button 26 of remote control unit 12 during actual operation (the object identifying phase), in response to which the preselected pattern or sequence of lights is displayed by object identifying device 14.

Operation of the object identification system 10 of the present invention will now be described with reference to FIGS. 1-4. During the setup phase, the user presses control button 24 to select a first pattern or sequence of lights. For example, a first pressing of the control button 24 will establish a first pattern or sequence of lights, and that pattern or sequence of lights will be displayed by the lights 32 on object identifying device 14. Then, a second pressing of control button 24 will establish a second pattern or sequence of lights, which will be displayed by lights 32 on object identifying device 14. When the user arrives at the desired pattern or sequence of lights, he or she will press control button 26 to lock in the desired pattern or sequence of lights. In the latter regard, it will be obvious to those of skill in the art that other operations of the setup phase can be implemented within the scope of the present invention, as defined in the appended claims. It is also to be understood that the operation of setting up and establishing the desired pattern or sequence of lights is controlled by the MPU 40 of the remote control unit 12 and the MPU 46 of the object identifying device 14, both of which are appropriately programmed, as will be obvious to those of skill in the art.

Once the pattern or sequence of lights is established during the setup phase, the object identification system 10 is ready for actual operation. When the user desires to locate an item (such as luggage) to which the object identifying device 14 is attached, the user merely presses control button 26, and the MPU 40 of remote control unit 12 activates the transmitter 42 thereof to send a polling signal to the object identifying device 14. This polling signal can consist of a signal of a certain frequency preset by the manufacturer, but more preferably consists of a signal selected by the user from among a plurality of frequencies in accordance with a procedure described below. When polling signal is received by the receiver 34 of the object identifying device 14, the polling signal is converted to digital form, and is then passed on to the MPU 46 of the object identifying device 14. The MPU 46 then determines whether the polling signal is from the proper remote control unit 12. Once the MPU 46 determines that the polling signal is from the proper remote control unit 12, it activates drivers 48a-48n in a manner corresponding to the preselected pattern or sequence of lights so as to illuminate lights 32a-32n in the appropriate pattern or sequence. It is to be understood that the generation and recognition of the polling signal is controlled by the MPU 40 of the remote control unit 12 and the MPU 46 of the object identifying device 14, both of which are appropriately programmed, as will be obvious to those of skill in the art.

As mentioned above, preferably, the polling signal sent by remote control unit 12 consists of a signal having a frequency selected by the user from among a plurality of frequencies. The user selects the desired frequency during the setup phase of operation. Specifically, during the setup phase, the user presses an additional control button (not shown) or presses both control buttons 24 and 26 to enter the frequency setting phase. Then, by pressing one of the control buttons (e.g., control button 24), the user can select a first frequency. By pressing the same control button a second time, a different frequency can be selected, and so forth, until the desired frequency is reached. Once the desired frequency is reached, pressing of the addition control button or both control buttons 24 and 26 locks in the desired frequency. As was the case with the setting of the pattern or sequence of lights described above, as well as the generation and recognition of the polling signal also described above, the operation of setting the desired frequency of the polling signal is also controlled by the MPU 40 of the remote control unit 12 and the MPU 46 of the object identifying device 14, both of which are appropriately programmed, as will be obvious to those of skill in the art.

Thus, the present invention comprises an object identification system and device which completely preclude false activation of a response signal generated by a device attached to an object to be located. That is to say, the present invention provides an object identification system which provides the user with the capability of employing a remote control unit to control an identification device fixed to an object so as to select a specific pattern of lights located on the identification device so that, in response to a polling signal subsequently generated by the remote control unit, the identification device uniquely identifies the object by activating and displaying the specifically selected, unique pattern of lights located on the device.

While preferred forms and arrangements have been shown in illustrating the invention, it is to be understood that various changes and modifications may be made without departing from the spirit and scope of this disclosure.

1. An object identifying system, comprising:
a remote control unit operable by a user to generate a polling signal; and
an identification device attachable to an object belonging to the user, and having a plurality of lights mounted thereon, said identification device being responsive to the polling signal generated by said remote control unit for illuminating the plurality of lights in such a manner as to identify the object as belonging to the user.

2. The system of claim 1, wherein the plurality of lights is illuminated in a certain sequence in response to the polling signal.

3. The system of claim 2, wherein the remote control unit is used by the user to preset the certain sequence in which the lights are illuminated in response to the polling signal.

4. The system of claim 1, wherein the plurality of lights is illuminated in a certain pattern in response to the polling signal.

5. The system of claim 4, wherein the remote control unit is used by the user to preset the certain pattern in which the lights are illuminated in response to the polling signal.

6. The system of claim 1, wherein the remote control unit comprises a first control button for generating a polling signal and a second control button for programming the identification device to illuminate the plurality of lights in such a manner as to identify the object as belonging to the user.

7. The system of claim 6, wherein the remote control unit further comprises a microprocessor unit connected to the first and second control buttons, and responsive thereto for generating corresponding outputs, and a transmitter connected to said microprocessor unit for transmitting the corresponding outputs to the identification device.

8. The system of claim 7, wherein said identification device comprises a receiver for receiving the corresponding outputs transmitted by said transmitter, and a microprocessor unit connected to said receiver for receiving the corresponding outputs therefrom.

9. The system of claim 8, wherein said microprocessor unit of said identification device responds to a first type of the corresponding outputs by programming said identification device to illuminate the plurality of lights in at least one of a certain sequence and a certain pattern so as to identify the object as belonging to the user.

10. The system of claim 9, wherein said microprocessor unit of said identification device responds to a second type of the corresponding outputs by illuminating the plurality of lights in said at least one of the certain sequence and the certain pattern so as to identify the object as belonging to the user.

11. The system of claim 10, wherein said identification device further comprises a plurality of drivers connected to said microprocessor unit of said identification device for illuminating the plurality of lights.

12. The system of claim 1, wherein said identification device comprises a peripheral portion and a central portion, said plurality of lights being disposed in said peripheral portion, and identification information relating to the user being displayed in said central portion.

13. An object identifying device attachable to an object belonging to a user, said device comprising:
a plurality of lights disposed on said device;
receiving means for receiving a polling signal; and
illuminating means responsive to the polling signal for illuminating the plurality of lights in such a manner as to identify the object as belonging to the user.

14. The device of claim 13, wherein the plurality of lights is illuminated in a certain sequence in response to the polling signal.

15. The device of claim 13, wherein the plurality of lights is illuminated in a certain pattern in response to the polling signal.

16. The device of claim 13, further comprising programming means responsive to a programming signal for programming said illuminating means to illuminate the plurality of lights in at least one of a certain sequence and a certain pattern so as to identify the object as belonging to the user.

17. The device of claim 13, further comprising a receiver for receiving a programming signal, and a microprocessor unit connected to said receiver and responsive to the programming signal for setting at least one of a certain sequence of illumination of the plurality of lights and a certain pattern of illumination of the plurality of lights.

18. The device of claim 13, further comprising a receiver for receiving the polling signal, and a microprocessor unit connected to said receiver and responsive to the polling signal for illuminating said plurality of lights in such a manner as to identify the object as belonging to the user.

19. The device of claim 18,wherein said plurality of lights is illuminated in at least one of a certain sequence and a certain pattern so as to identify the object as belonging to the user.

20. The device of claim 18, further comprising a plurality of drivers connected between said microprocessor unit and said plurality of lights for illuminating said plurality of lights in response to an output from said microprocessor unit.
